(19) United States
(12) Patent Application Publication
(10) Pub. No.: US 2012/0213235 A1
(43) Pub. Date: Aug. 23, 2012

(54) OPTICAL COUPLERS AND ACTIVE OPTICAL MODULES USING THE SAME

(75) Inventors: Hong-Seok SEO, Daejeon (KR); Joon Tae AHN, Daejeon (KR); Bong Je PARK, Daejeon (KR); Jung-Ho SONG, Daejeon (KR)

(73) Assignee: ELECTRONICS AND TELECOMMUNICATIONS RESEARCH INSTITUTE, Daejeon (KR)

(21) Appl. No.: 13/345,774

(22) Filed: Jan. 9, 2012

(30) Foreign Application Priority Data
Feb. 21, 2011 (KR) 10-2011-0015167

(51) Int. Cl. H01S 3/067

(52) U.S. Cl. 372/6

(57) ABSTRACT

Provided are an optical coupler and an active optical module including the same. The optical coupler includes at least one first optical fiber, a second optical fiber, and a hollow optical block. The at least one first optical fiber transfers pump light. The second optical fiber includes a cladding with a facet enlarged from a first outer diameter to a second outer diameter, and passes the pump light which is transferred through the first optical fiber. The hollow optical block includes a through hole, an incident surface, and a coupling surface. The through hole passes the cladding with the first outer diameter. The incident surface is connected to the first optical fiber at a side end of the through hole. The coupling surface is joined to the facet of the second optical fiber at the other side end of the through hole facing the incident surface.

### CROSS-REFERENCE TO RELATED APPLICATIONS

This U.S. non-provisional patent application claims priority under 35 U.S.C. §119 of Korean Patent Application No. 10-2011-0015167, filed on Feb. 21, 2011, the entire contents of which are hereby incorporated by reference.

### BACKGROUND OF THE INVENTION

The present invention disclosed herein relates to an optical coupler and an active optical module thereof, and more particularly, to an optical coupler and an active optical module thereof, which transfer pump light to an optical fiber.

Laser light may be oscillated by various kinds of lasers. Examples of lasers may comprise semiconductor-based layers, crystal-based solid lasers, and optical fiber lasers. The optical fiber laser includes an optical fiber having a double cladding structure. The optical fiber laser generates laser light by supplying pump light to a core with an active medium added thereto. Therefore, by efficiently supplying pump light to a core of an optical fiber, a high-output optical fiber laser is realized.

### SUMMARY OF THE INVENTION

The present invention provides an optical coupler and an active optical module thereof, which efficiently supply pump light to a core of an optical fiber.

The present invention also provides an optical coupler and an active optical module thereof, which increase or maximize the coupling efficiency of an optical fiber.

Embodiments of the present invention provide optical couplers including: at least one first optical fiber transferring pump light; a second optical fiber including a cladding with a facet enlarged from a first outer diameter to a second outer diameter, and transmitting the pump light which is transferred through the first optical fiber; and a hollow optical block including a through hole passing the cladding with the first outer diameter, an incident surface connected to the first optical fiber at a side end of the through hole, and a coupling surface joined to the facet of the second optical fiber at the other side end of the through hole facing the incident surface.

In some embodiments, the coupling surface of the hollow optical block may include an inner tapering region of which an inner diameter increases toward a side of the hollow optical block.

In other embodiments, the facet of the second optical fiber may include an inclined facet joined to the inner tapering region of the hollow optical block.

In still other embodiments, the hollow optical block may have elasticity by which an inner diameter of the hollow optical block is increased and decreased in the inner tapering region.

In even other embodiments, an outer diameter of the hollow optical block may be the same as an outer diameter of a second portion of the second optical fiber, at the incident surface.

In yet other embodiments, the coupling surface may include a side wall of the hollow optical block parallel to the incident surface.

In further embodiments, the facet of the second optical fiber may include a vertical facet joined to the side wall of the hollow optical block.

In still further embodiments, an outer diameter of hollow optical block at the incident surface may be the same as an outer diameter at the side wall.

In even further embodiments, the hollow optical block may further include an external tapering region concentrating the pump light on the second optical fiber when an outer diameter thereof at the incident surface is greater than an outer diameter of a second portion of the cladding.

In yet further embodiments, the second optical fiber may further include a core transmitting single-mode light or multi-mode light.

In much further embodiments, the core may include a rare-earth element.

In other embodiments of the present inventive concept, active optical modules include: a pump light source supplying pump light; an optical coupler including: at least one first optical fiber transferring the pump light; a second optical fiber including a cladding with a facet enlarged from a first outer diameter to a second outer diameter, and transmitting the pump light which is transferred through the first optical fiber; and a hollow optical block including a through hole passing the cladding with the first outer diameter, an incident surface connected to the first optical fiber at a side end of the through hole, and a coupling surface joined to the facet of the second optical fiber at the other side end of the through hole facing the incident surface; a first optical element formed at an end of the second optical fiber which passes through the optical coupler; and a second optical element formed at the other end of the second optical fiber facing the first optical element, and emitting the laser light which is generated by the second optical fiber.

In some embodiments, the active optical module may have a forward pumping mode where the hollow optical block of the optical coupler is disposed in a direction from the first optical element to the second optical element.

In other embodiments, the active optical module may have a backward pumping mode where the hollow optical block of the optical coupler is disposed in a direction from the second optical element to the first optical element.

In still other embodiments, the optical coupler may be provided in plurality, and the active optical module may have a bidirectional pumping mode where hollow optical blocks of the optical couplers are disposed in a direction facing each other.

In even other embodiments, the optical coupler may be provided in plurality, and the active optical module may have a multiple forward pumping mode where hollow optical blocks of the optical couplers are disposed toward the first and second optical elements.

In yet other embodiments, each of the first and second optical elements may include first and second mirrors.

In further embodiments, the active optical module may further include a modulator formed at the optical fiber between the first and second mirrors.

In still further embodiments, each of the first and second optical elements may include first and second isolators.

In even further embodiments, the active optical module may further include a signal source or master oscillator formed at the second optical fiber outside the first isolator facing the second optical element.

### BRIEF DESCRIPTION OF THE DRAWINGS

The accompanying drawings are included to provide a further understanding of the present inventive concept, and are incorporated in and constitute a part of this specification. The drawings illustrate exemplary embodiments of the present inventive concept and, together with the description, serve to explain principles of the present inventive concept. In the drawings:

FIG. 1 is a sectional view illustrating an optical coupler according to a first embodiment of the present inventive concept;

FIG. 2 is a sectional view illustrating an application example of FIG. 1;

FIGS. 3A to 3D are process-sectional views illustrating a method of manufacturing an optical coupler, according to a first embodiment of the present inventive concept;

FIG. 4 is a sectional view illustrating an optical coupler according to a second embodiment of the present inventive concept;

FIG. 5 is a sectional view illustrating an application example of FIG. 4;

FIGS. 6A to 6D are process-sectional views illustrating a method of manufacturing an optical coupler, according to a second embodiment of the present inventive concept;

FIGS. 7A to 7D are views illustrating an active optical module according to a first embodiment of the present inventive concept;

FIGS. 8A to 8D are views illustrating an active optical module according to a second embodiment of the present inventive concept;

FIGS. 9A to 9D are views illustrating an active optical module according to a third embodiment of the present inventive concept; and

FIGS. 10A to 10D are views illustrating an active optical module according to a fourth embodiment of the present inventive concept.

### DETAILED DESCRIPTION OF PREFERRED EMBODIMENTS

Preferred embodiments of the present inventive concept will be described below in more detail with reference to the accompanying drawings. The present inventive concept may, however, be embodied in different forms and should not be constructed as limited to the embodiments set forth herein. Rather, these embodiments are provided so that this disclosure will be thorough and complete, and will fully convey the scope of the present inventive concept to those skilled in the art.

In the specification, it will be understood that when an element such as a layer, film, region, or substrate is referred to as being “on” another element, it can be directly on the other element or intervening elements may also be present. In the figures, the dimensions of layers and regions are exaggerated for clarity of illustration. Also, though terms like a first, a second, and a third are used to describe various regions and layers in various embodiments of the present inventive concept, the regions and the layers are not limited to these terms. These terms are used only to discriminate one region or layer from another region or layer. Therefore, a layer referred to as a first layer in one embodiment can be referred to as a second layer in another embodiment. An embodiment described and exemplified herein includes a complementary embodiment thereof.

Hereinafter, optical couplers according to embodiments of the present inventive concept will be described in detail with reference to the accompanying drawings.

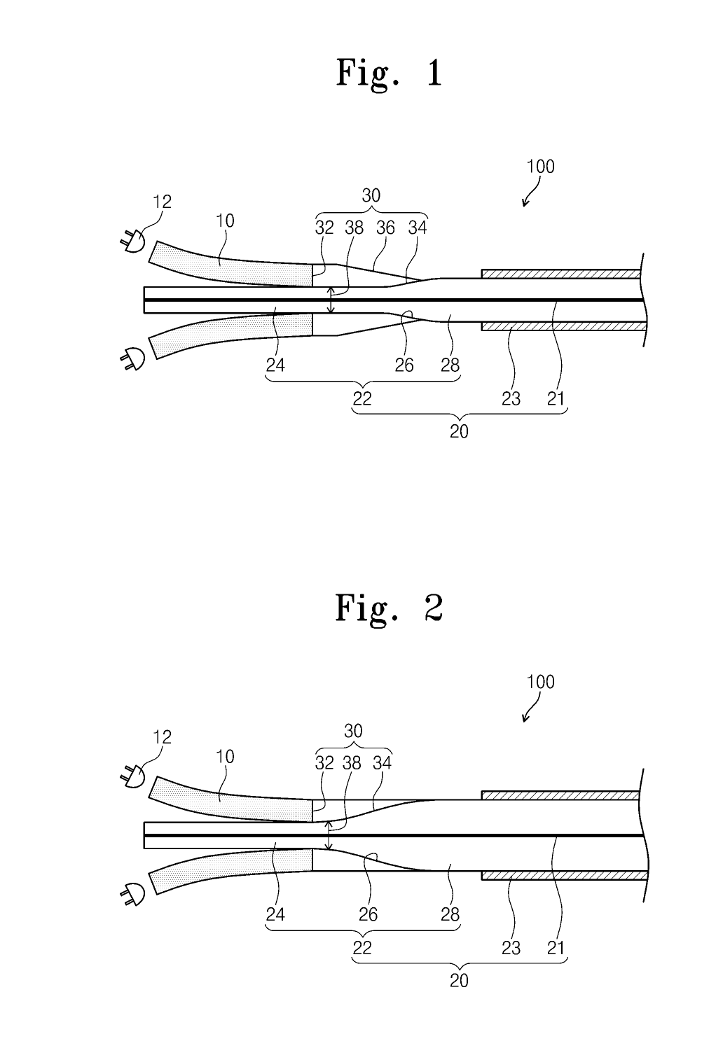

FIG. 1 is a sectional view illustrating an optical coupler according to a first embodiment of the present inventive concept.

Referring to FIG. 1, an optical coupler 100 according to the first embodiment of the present inventive concept may include a hollow optical block 30 that has a through hole 38 passing a first portion 24 of a first cladding 22, and an inner tapering region 34 which is joined to an inclined facet 26, between first and second portions 24 and 28 of the first cladding 22. An incident surface 32 of the hollow optical block 30 may be connected to a first optical fiber 10. The inner tapering region 34 may be a coupling surface joined to the inclined facet 26 of a second optical fiber 20. The second optical fiber 20 may receive pump light from the first portion 24 and inclined facet 26 of the first cladding 22. The hollow optical block 30 and the first cladding 22 of the second optical fiber 20 may have the same refractive index.

Accordingly, the optical coupler 100 includes the hollow optical block 30 having the inner tapering region 34 joined to the inclined facet 26 of the first cladding 22, thus increasing or maximizing coupling efficiency.

The optical fiber 10 may be provided in plurality. The optical fibers 10 may have a core and cladding structure for transferring pump light to the incident surface 32 of the hollow optical block 30, or include a pump fiber of a silica glass having no the core and cladding structure. Also, the first optical fibers 10 may include a multi-mode fiber that is configured with a hard polymer clad or a hard silica clad fiber. The first optical fibers 10 may have a diameter equal to or less than the thickness of the incident surface 32 of the hollow optical block 30. For example, the first optical fibers 10 may have a numerical aperture about 0.15 or more, and a core diameter of about 100 μm or more. The first optical fibers 10 may be connected to the incident surface 32 of the hollow optical block 30. The first optical fibers 10 may be connected in a single layer or a multi-layer, around the first portion 24 of the first cladding 22 of the second optical fiber 20.

The pump light source 12 may generate pump light. The pump light source 12 may include a Laser Diode (LD) that generates the pump light with a power supplied from the outside. The laser diode may be manufactured as a single source (for example, a single emitter) or in a bar type or a stack type. The pump light source 12 may generate pump light having at least one of 808 nm, 915 nm, 950 nm, 980 nm, 1480 nm, and other wavelength bands, according to the kinds of light emitting materials.

The pump light may be transferred to the hollow optical block 30 and second optical fiber 20 through the first optical fibers 10. All of the pump light may be incident on the first cladding 22 of the second optical fiber 20. This is because the first optical fibers 10, the hollow optical block 30, and the first cladding 22 of the second optical fiber 20 have the same refractive index. The pump light may travel from the first optical fibers 10 and hollow optical block 30 to the first cladding 22 of the second optical fiber 20, and then be absorbed into the first core 21.

The second optical fiber 20 may be a photonic crystal optical fiber or a double cladding optical fiber that includes the core 21, the first cladding 22 surrounding the core 21, and the second cladding 23. The first core 21 may absorb pump light traveling in a direction where the first optical fibers 10 and hollow optical block 30 are joined to the first cladding 22. The first core 21 may include an active material that absorbs pump light to emit Amplified Spontaneous Emission (ASE). The active material may include a rare-earth element. The rare-earth element may absorb pump light, and thus, an electron excited to a metastable state is stabilized, thereby emitting laser light of a single wavelength. The rare-earth element may include at least one of erbium (Er), ytterbium (Yb), and thulium (Tm). Er, Yb, and Tm may generate laser light of about 1550 nm, laser light of about 1080 nm, and laser light of about 2000 nm, respectively. The first core 21 may include a single-mode core or a multi-mode core. The first core 21 may have a constant diameter without having a discontinuously cut surface, in the first cladding 22. The first core 21 may have a refractive index higher than that of the first and second claddings 22 and 23.

Each of the first and second claddings 22 and 23 may include a silica glass and a polymer component. In a double cladding optical fiber, the first and second claddings 22 and 23 may have a refractive index lower than that of the first core 21. The first cladding 22 may have a refractive index higher than that of the second cladding 23. The first core 21 and first cladding 22 may have a refractive index difference of about 0.001 to about 0.01 therebetween. The second cladding 23 may include a fluorine-based polymer. The first cladding 22 may include the first portion 24, the inclined facet 26, and the second portion 28. The first portion 24 may have an outer diameter less than that of the second portion 28. The inclined facet 26 may be formed through thermal treatment as well as etching of the first cladding 22.

Likewise, the first core 21 of a photonic crystal optical fiber may include a silica glass with a rare-earth element added thereto. An interface region between the first core 21 of the photonic crystal optical fiber and the first cladding 22 may include a silica glass where a plurality of fine pores are arranged in a length direction without number. The second cladding 23 of a photonic crystal optical fiber may include a silica glass having the same refractive index as that of the first core 21, in which case a plurality of fine pores in an interface region between the first and second claddings 22 and 23 are arranged in a length direction, and the size of each fine pore is greater than that of each pore in the interface region between the first core 21 and the first cladding 22.

The hollow optical block 30 may include the through hole 38 passing the first portion 24 of the first cladding 22. The hollow optical block 30 may include the inner tapering region 34 which is joined to the inclined facet 26 of the first cladding 22 at another side facing the incident surface 32. The inner tapering region 34 of the hollow optical block 30 may be joined to the inclined facet 26.

The hollow optical block 30 may have an outer diameter less than that of the second portion 28, around the inner tapering region 34. That is, when the hollow optical block 30 is coupled to the second optical fiber 20, the inclined facet 26 may be exposed. The inner tapering region 34 may not cover the entirety of the inclined facet 26. Accordingly, the inner tapering region 34 of the hollow optical block 30 may have an area less than that of the inclined facet 26 of the second optical fiber 20. However, when a coupling area between the inner tapering region 34 and the inclined facet 26 is excessively small, transfer efficiency of pump light can be reduced. When the inner tapering region 34 of the hollow optical block 30 is joined to the inclined facet 26, transfer efficiency of pump light is the maximum in a case where the inclined facet 26 is not exposed, but although the inclined facet 26 is exposed to a coupling portion, the transfer efficiency of the pump light can be the maximum within a certain range.

The inner tapering region 34 may be adjusted finely in inner diameter of the through hole 32. The hollow optical block 30 may have elasticity in the inner tapering region 34. The hollow optical block 30 may have an outer diameter greater than that of the second portion 28 of the first cladding 22 at an incident surface, and include an outer tapering region 36 that is reduced toward the inner tapering region 34 in outer diameter so as to have the same outer diameter as that of the second portion 28. The external tapering region 36 may concentrate pump light on the first cladding 22, in the hollow optical block 30.

In the first optical fibers 10, the loss of pump light traveling toward the hollow optical block 30 and second optical fiber 20 can be minimized by a Beam Parameter Product (BPP) value. The BPP value may correspond to the multiplication of the outer diameter of an optical fiber, where light travels, and the numerical aperture (NA) in the optical fiber. Herein, NA is a value for determining an incident angle affecting spread of light. NA may correspond to a sine value of the maximum angle at which light is not refracted outward from the inside of an optical fiber but travels through total reflection. When the outer diameter of an optical fiber and its NA are determined, the BPP value may be constant. Also, when a BPP value of an input terminal is less than that of an output terminal, pump light is not lost.

For example, the first cladding 22 having a NA of about 0.46 may have a first outer diameter of about 125 μm at the first portion 24, and have a second outer diameter of about 200 μm at the second portion 28. The hollow optical block 30 may have an outer diameter of about 375 μm at the incident surface 32, and have an inner diameter of about 125 μm. Also, the hollow optical block 30 may be enlarged to an inner diameter of about 200 μm in a direction facing the incident surface 32, in the inner tapering region 34. Moreover, the outer tapering block 30 of the hollow optical block 30 may be reduced from about 375 μm to about 200 μm in outer diameter. The first optical fibers 10, which have a NA of about 0.22 toward the incident surface 32 of the hollow optical block 30 and have an outer diameter of about 125 μm, may be connected. About six first optical fibers 10 may be joined to the incident surface 32.

A BPP value of an input terminal corresponding to the incident surface 32 of the hollow optical block 30 is about 82.5 (which is 375 μm×0.22). Also, a BPP value of an output terminal, corresponding to the second portion 28 of the first cladding 22 which is joined to the inner tapering region 34 of the hollow optical block 30, is about 92 (which is 200 μm×0.46).

Therefore, the optical coupler 100 has a BPP value less than that of the output terminal corresponding to the second portion 28 of the first cladding 22 which is joined to the inner tapering region 34 of the hollow optical block 30, at the incident value 32, and thus can minimize the loss of pump light. Also, the loss of the pump light can be minimized in the inner tapering region 34 and the inclined facet 26, thus increasing or maximizing coupling efficiency.

FIG. 2 is a sectional view illustrating an application example of FIG. 1.

When the outer diameter of the incident surface 32 of the hollow optical block 30 is the same as that of the second portion 28 of the first cladding 22, the hollow optical block 30 may have only the inner tapering region 34 in a direction facing the incident surface 32. In the optical coupler 100, therefore, when the outer diameter of the incident surface 32 of the hollow optical block 30 is the same as that of the second portion 28 of the first cladding 22, the hollow optical block 30 may not have the external tapering region 36.

A method of manufacturing the optical coupler 100, according to a first embodiment of the present inventive concept, will be described below in detail.

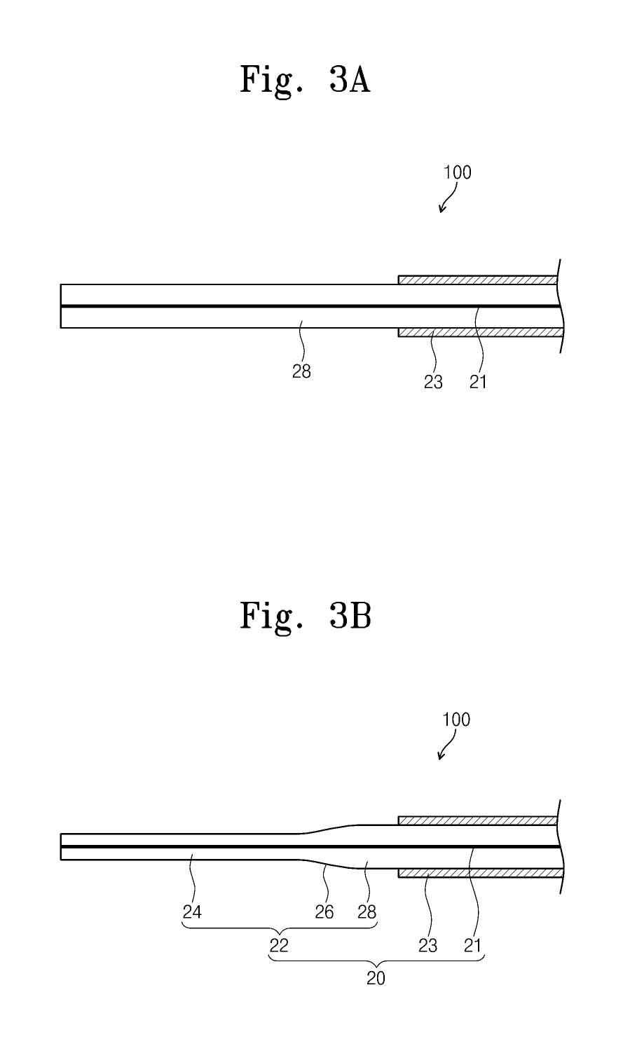

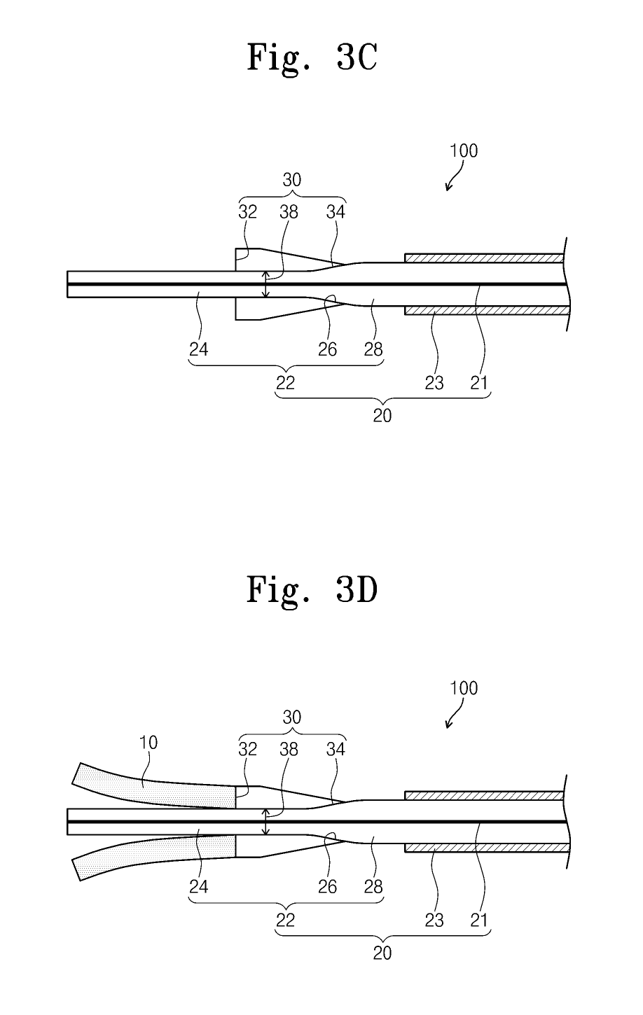

FIGS. 3A to 3D are process-sectional views illustrating a method of manufacturing an optical coupler, according to a first embodiment of the present inventive concept.

Referring to FIG. 3A, the first cladding 22 may be exposed by removing the second cladding 23 of the second optical fiber 20. The second cladding 23 may be removed by an etching process. For example, the second cladding 23 may be removed by an ashing process or a chemical etching process. Also, the second cladding 23 may be removed by a mechanical etching process. The first cladding 22 of the first portion 28 exposed from the second cladding 23, for example, may have a second outer diameter of about 200 μm.

Referring to FIG. 3B, the inclined facet 26 may be formed by removing a portion of the first cladding 22 at a proper length. The inclined facet 26 may be formed by a wet etching process or a dry etching process. The inclined facet 26 may be formed perpendicularly to the first core 12 of the second optical fiber 20, or to be inclined. The wet etching process may etch the first cladding 22 with fluorine or a buffered etching solution including fluorine. The wet etching process may include a dip process that allows the first cladding 22 to be dipped in the buffered etching solution. The dry etching process may include a CO₂ or femtosecond (fs) laser etching process. A CO₂ or fs laser may etch the first cladding 22 through ablation. The CO₂ or fs laser may etch the first cladding 22 while rotating the first cladding 22. For example, the first cladding 22 having the second outer diameter of about 200 μm, for example, may be etched to the first outer diameter of about 125 μm by the wet etching process or dry etching process. The first portion 24 having the first outer diameter may be wet-etched, and the inclined facet 26 may be formed by dry-etching, in a simultaneous etching process. The first cladding 22 may include the inclined facet 26 corresponding to a step height between the first portion 24 of the first outer diameter and the second portion 28 of the second outer diameter. Accordingly, the inclined facet 26 may have a step height of about 75 μm and be formed to be inclined.

Referring to FIG. 3C, the hollow optical block 30, which has the through hole 38 passing the first portion 24 of the first cladding 22 and has the inner tapering region 34 corresponding to the inclined facet 26, is joined to the second optical fiber 20.

Referring to FIG. 3D, the first optical fibers 10 may be joined to the incident surface 32 of the hollow optical block 30. The first optical fibers 10 may be joined to the incident surface 32 of the hollow optical block 30, in bundle. The first optical fibers 10 may be bundled by a clamp (not shown), around the second optical fiber 20. The first optical fibers 10 may be spliced to the incident surface 32 by a micro torch, an electric heater, or the CO₂ laser. The micro torch may melt-join the first optical fibers 10 to the incident surface 32 with a gas input type of flame. The electric heater may melt-join the first optical fibers 10 to the incident surface 32 at a high temperature. The CO₂ laser may melt-join the first optical fibers 10 to the incident surface 32 more accurately than the micro torch. The first optical fibers 10 may be spliced to the incident surface 32 in the form of six petals.

Therefore, the method of manufacturing the optical coupler 100, according the first embodiment of the present inventive concept, joins the inner tapering region 34 of the hollow optical block 30 to the inclined facet 26 between the first and second portions 24 and 28 of the first cladding 22, and connects the first optical fiber 10 to the incident surface 32.

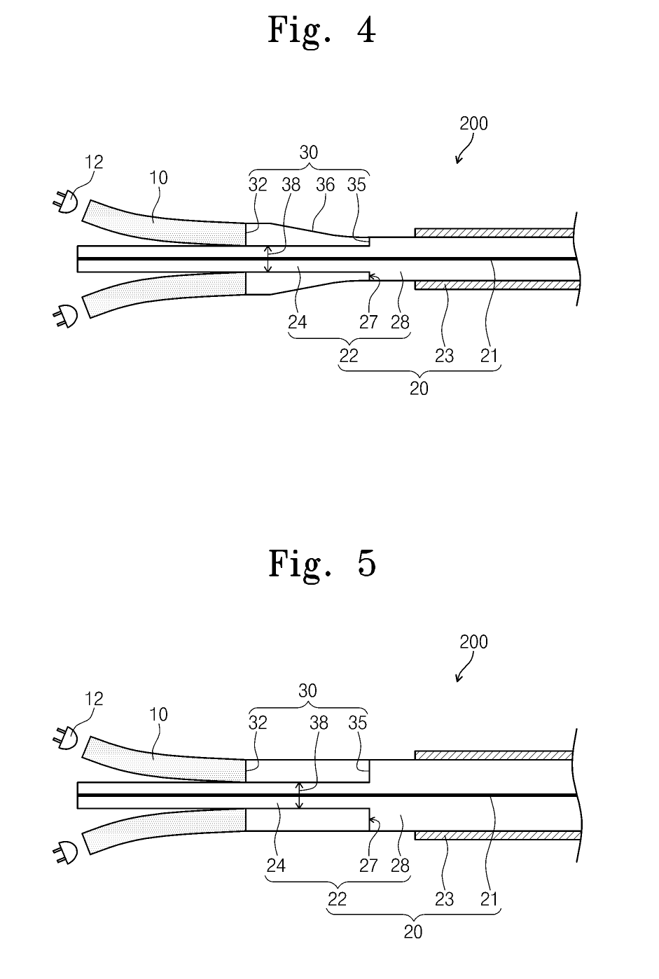

FIG. 4 is a sectional view illustrating an optical coupler according to a second embodiment of the present inventive concept.

Referring to FIG. 4, an optical coupler 200 according to the second embodiment of the present inventive concept may include a hollow optical block 30 having a side wall 35 that is joined to a vertical facet 27 of a first cladding 22. The side wall 35 of the hollow optical block 30 may correspond to the inner tapering region 34 of the optical coupler 100 according to the first embodiment of the present inventive concept. The side wall 35 may be parallel to an incident surface 32. Also, the vertical facet 27 of the first cladding 22 may correspond to the inclined facet 26 of the optical coupler 100 according to the first embodiment of the present inventive concept.

The hollow optical block 30 may include an outer tapering region 36 that has an outer diameter less than that of the incident surface 32 at the side wall, and is formed between the incident surface 32 and the side wall 35. The outer tapering region 36 may be adiabatically reduced in a direction facing the incident surface 32, in outer diameter of the hollow optical block 30.

Accordingly, the optical coupler 200 can decrease the loss in supplying pump light, and increase or maximize coupling efficiency.

FIG. 5 is a sectional view illustrating an application example of FIG. 4.

Referring to FIG. 5, when the outer diameter of the incident surface 32 of the hollow optical block 30 is the same as that of a second portion 28 of a second optical fiber 20, the outer diameter of the incident surface 32 of the hollow optical block 30 may be the same as that of the side wall 35. The hollow optical block 30 may have a certain silica tube type with an inner diameter and outer diameter.

A plurality of first optical fibers 10 and a second optical fiber 20 have been described above in the first embodiment of the present inventive concept, and thus, their detailed description is not provided.

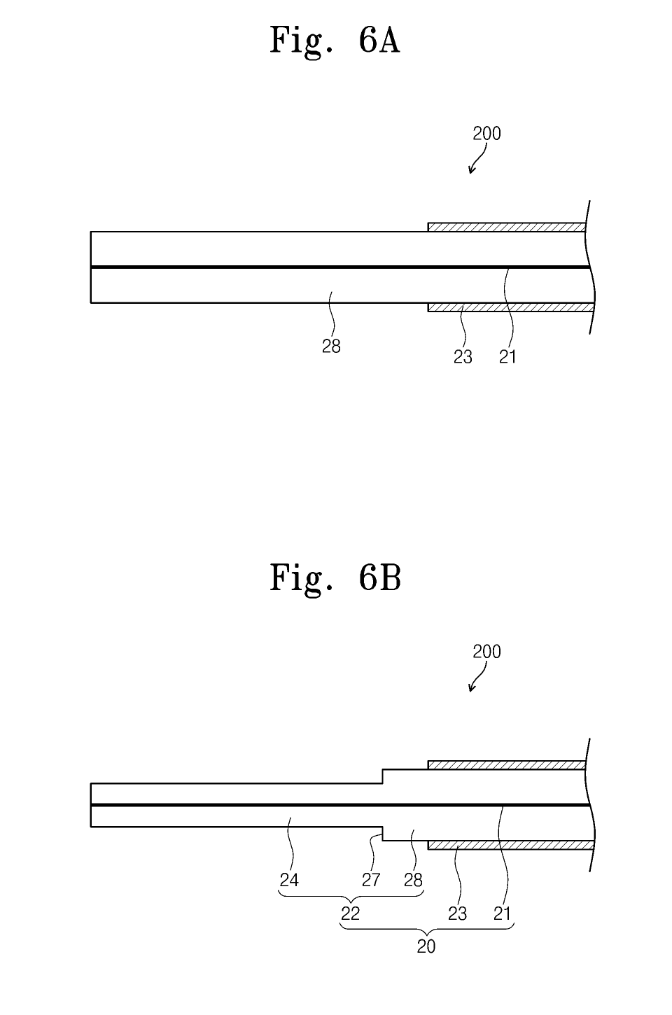

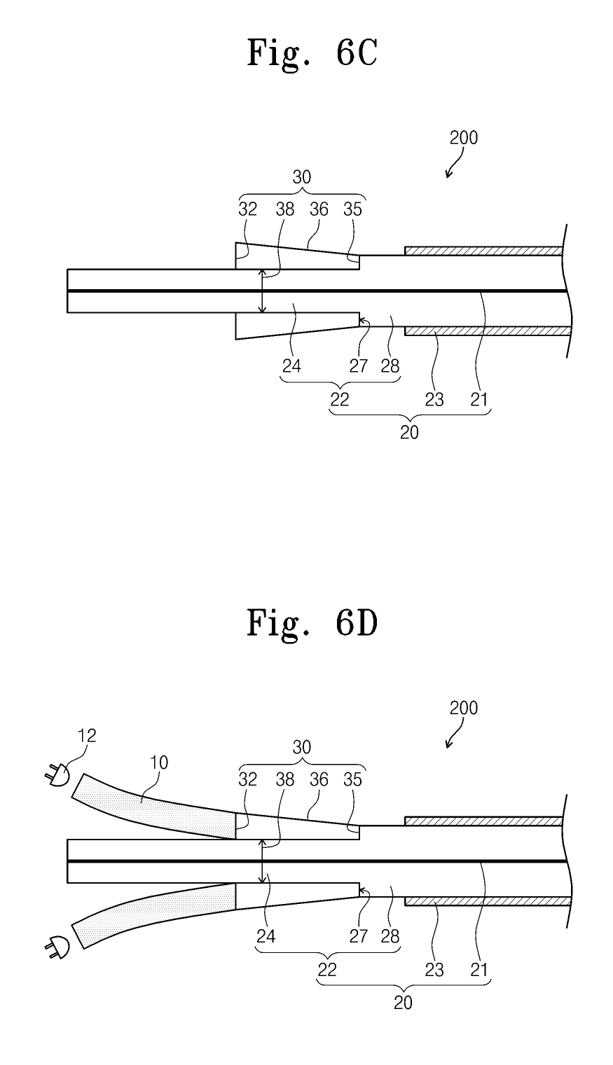

FIGS. 6A to 6D are process-sectional views illustrating a method of manufacturing an optical coupler, according to a second embodiment of the present inventive concept.

Referring to FIG. 6A, the first cladding 22 may be exposed by removing a second cladding 23 of a second optical fiber 20. The second cladding 23 may be removed by an etching process. For example, the second cladding 23 may be removed by an ashing process or a chemical etching process. Also, the second cladding 23 may be removed by a mechanical etching process. The first cladding 22 in a first portion 28 exposed from the second cladding 23, for example, may have a second outer diameter of about 200 μm.

Referring to FIG. 6B, a vertical facet 27 may be formed by removing a portion of the first cladding 22 at a certain line width. The vertical facet 27 may be formed by a wet etching process or a dry etching process. The vertical facet 27 may be formed perpendicularly to the first core 12 of the second optical fiber 20. The wet etching process may etch the first cladding 22 with fluorine or a buffered etching solution including fluorine. The wet etching process may include a dip process that allows the first cladding 22 to be dipped in the buffered etching solution. The dry etching process may include a CO₂ or fs laser etching process. A CO₂ or fs laser may etch the first cladding 22 through ablation. The CO₂ or fs laser may etch the first cladding 22 while rotating the first cladding 22. For example, the first cladding 22 having the second outer diameter of about 200 μm, for example, may be etched to the first outer diameter of about 125 μm by the wet etching process or dry etching process. The first portion 24 having the first outer diameter may be wet-etched, and the vertical facet 27 may be formed by dry-etching.

Referring to FIG. 6C, the hollow optical block 30, which has the through hole 38 passing the first portion 24 of the first cladding 22 and has the side wall 35 corresponding to the vertical facet 27, is joined to the second optical fiber 20.

Referring to FIG. 6D, the first optical fibers 10 may be joined to the incident surface 32 of the hollow optical block 30. The first optical fibers 10 may be joined to the incident surface 32 of the hollow optical block 30, in bundle. The first optical fibers 10 may be bundled by a clamp (not shown), around the second optical fiber 20. The first optical fibers 10 may be spliced to the incident surface 32 by a micro torch, an electric heater, or the CO₂ laser. The micro torch may melt-join the first optical fibers 10 to the incident surface 32 with a gas input type of flame. The first optical fibers 10 may be melt joined to the first optical fibers 10 at a high temperature by electric heater. The CO₂ laser may melt-join the first optical fibers 10 to the incident surface 32 more accurately than the micro torch. The first optical fibers 10 may be spliced to the incident surface 32 in the form of six petals.

Therefore, the method of manufacturing the optical coupler 200, according the second embodiment of the present inventive concept, joins the side wall 35 of the hollow optical block 30 to the vertical facet 27 between the first and second portions 24 and 28 of the first cladding 22, and connects the first optical fiber 10 to the incident surface 32.

The optical couplers 100 or 200 enable the realization of an optical fiber laser and optical fiber amplifier that have a forward pumping mode or backward pumping mode according to a direction where laser light is outputted. The optical fiber laser and optical fiber amplifier may have a bidirectional pumping mode that is formed by combining the forward pumping mode and backward pumping mode, and a multiple forward pumping mode. Herein, a direction where the first optical fibers 10 are connected at the facets 26 and 27 of the second optical fiber 20 may be defined as an incident direction of pump light, and the incident direction of the pump light may be defined as a direction of the hollow optical block 30, or a direction of the inner tapering region 26 and side wall 27 of the hollow optical block 30.

In the forward pumping mode, the incident direction of pump light may be the same as the output direction of laser light that is generated by the pump light. In the backward pumping mode, the incident direction of the pump light may be opposite to the output direction of the laser light that is generated by the pump light.

Accordingly, the kind of an operable active optical module may be changed according to the kinds of optical elements that are formed at both ends of the second optical fiber 20 in the optical couplers 100 or 200.

Hereinafter, the following description will be made on embodiments of an active optical module that has various kinds of pumping modes according to the kinds of optical elements which are formed at both ends of the second optical fiber 20 in the optical couplers 100 or 200.

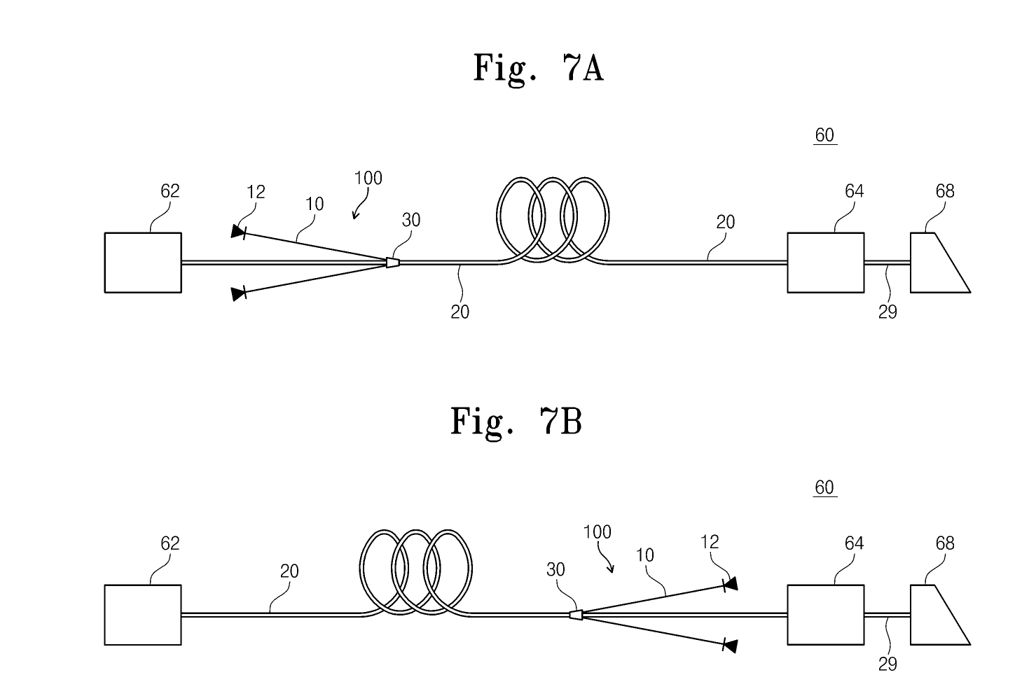

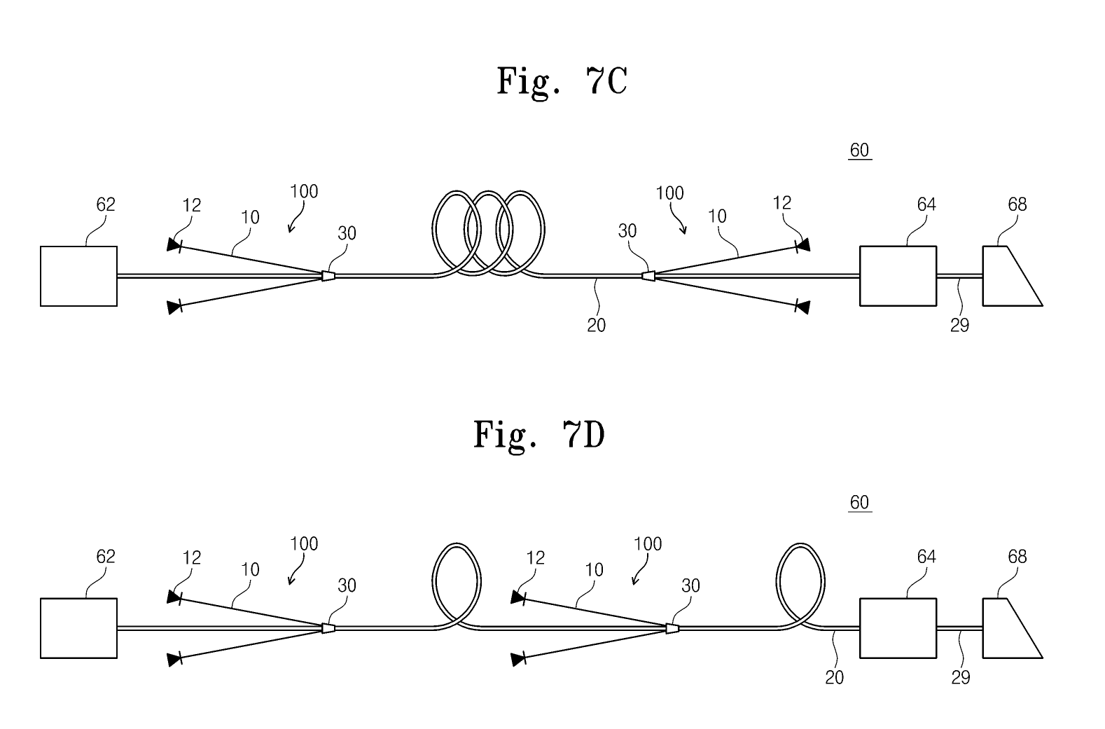

FIGS. 7A to 7D are views illustrating an active optical module 60 according to a first embodiment of the present inventive concept.

Referring to FIGS. 7A to 7D, the active optical module 60 may include a continuous output laser 60 including first and second mirrors 62 and 64 that are respectively formed at both side ends of a second optical fiber 20. The continuous output laser 60 may generate laser light having a single wavelength band. Specifically, when pump light is inputted from a pump light source 12 to a plurality of first optical fibers 10, laser light may be generated by a core 21 of the second optical fiber 20 between the first and second mirrors 62 and 64.

The first and second mirrors 62 and 64 may resonate the laser light that is generated by the second optical fiber 20. The first mirror 62 may reflect about 100% laser light, and reflect about 5% to about 20% of laser light. The first mirror 62 may include a full mirror or Fiber Bragg Grating (FBG) that totally reflects laser light. The second mirror 64 may include an FBG or output coupler that semi-transmits laser light. Laser light generated between the first and second mirrors 62 and 64 may be outputted to an end cap 68 or collimator through a pigtail optical fiber 29 extended from the second mirror 64.

Referring to FIG. 7A, the active optical module 60 may have a forward pumping mode where an optical coupler is disposed in a direction from the first mirror 62 to the second mirror 64. The optical coupler 30 may be one of optical couplers 100 and 200, and may be disposed adjacently to the first mirror 62. Herein, a hollow optical block 30 may be disposed in a direction from the first mirror 62 to the second mirror 64. Laser light may be outputted from the second mirror 64 to the end cap 68 through the pigtail optical fiber 29 of the second optical fiber 20. Pump light may travel along the second optical fiber 20 extended from the first mirror 62 to the second mirror 64, and be sufficiently absorbed. In the forward pumping mode, accordingly, the travel direction of pump light may be the same as the output direction of laser light, in the second optical fiber 20. In the forward pumping mode, moreover, the connection direction of the first optical fibers 10 joined to the second optical fiber 20 may be the same as the output direction of laser light.

Referring to FIG. 7B, the active optical module 60 may have a backward pumping mode where an optical coupler is disposed in a direction from the second mirror 64 to the first mirror 62. The optical coupler 30 may be one of optical couplers 100 and 200, and may be disposed at the second optical fiber 20 adjacent to the second mirror 64. The hollow optical block 30 may be disposed in a direction from the second mirror 64 to the first mirror 62. Pump light transferred through the first optical fibers 10 may travel along the second optical fiber 20 extended from the second mirror 64 to the first mirror 62, and be sufficiently absorbed. In the backward pumping mode, accordingly, the travel direction of pump light may be opposite to the output direction of laser light, in the second optical fiber 20.

Referring to FIG. 7C, the active optical module 60 may have a bidirectional pumping mode where a plurality of optical couplers are disposed to face each other at the second optical fiber 20 adjacent to the first and second mirrors 62 and 64. The plurality of optical couplers may be one of optical couplers 100 and 200. Herein, a plurality of hollow optical blocks 30 may be disposed to face each other between the first and second mirrors 62 and 64. Each of the optical couplers may transfer pump light in an opposite direction with each other to the second optical fiber 20 between the first and second mirrors 62 and 64. One of the optical couplers may be disposed in a forward direction at the second optical fiber 20 adjacent to the first mirror 62, and one of the optical couplers may be disposed in a backward direction at the second optical fiber 20 adjacent to the second mirror 64. Pump light may travel along the second optical fiber 20 between the first and second optical fibers 62 and 64, and be sufficiently absorbed into the core 21. In the bidirectional pumping mode, accordingly, laser light may be generated by pump light that is transferred in different opposite directions, in the second optical fiber 20 between the first and second mirrors 62 and 64.

Referring to FIG. 7D, the active optical module 60 may have a multiple forward pumping mode where a plurality of optical couplers are disposed in the same direction at a second optical fiber 20. The plurality of optical couplers may be one of optical couplers 100 and 200, and may transfer pump light to the second optical fiber 20, in a direction from a first mirror 62 to a second mirror 64. Each of optical couplers may be disposed in a forward direction between the first and second mirrors 62 and 64. When pump light supplied from the first optical coupler is depleted in the second optical fiber 20, pump light is resupplied from the second optical coupler, and thus, an output of laser light can sequentially increase. The intensity of the pump light supplied from the second optical coupler may be greater than that of the pump light supplied by the first optical coupler.

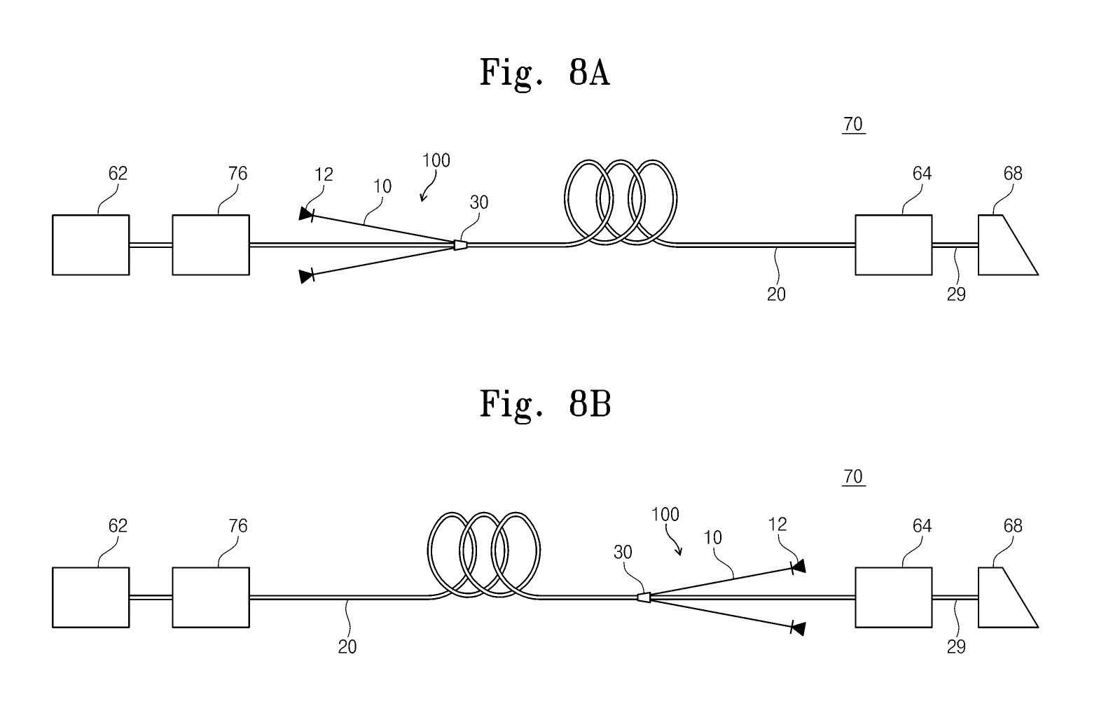

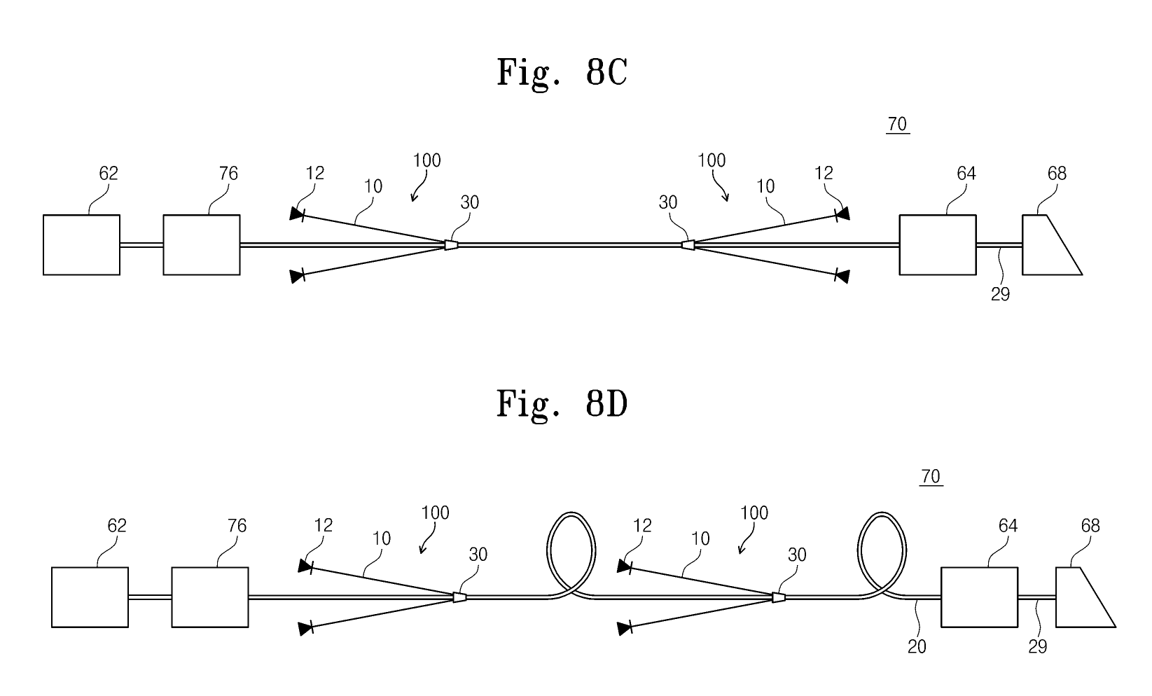

FIGS. 8A to 8D are views illustrating an active optical module 70 according to a second embodiment of the present inventive concept.

Referring to FIGS. 8A to 8D, the active optical module 70 may include an Q switching laser 70 or a mode locking laser where a first mirror 62 and a modulator 76 are formed at a second optical fiber 20 disposed in one side of the optical coupler 30, and a second mirror 64 is formed at the second optical fiber 20 disposed in the other side of the optical coupler. The Q switching laser 70 or mode locking laser may generate pulse laser light. Laser light may be generated from a core 21 between the first and second mirrors 62 and 64. The first and second mirrors 62 and 64 may resonate laser light.

The modulator 76 may modulate laser light with an analog or digital electric signal. The modulator 76 may switch laser light, generated between the first and second mirrors 62 and 64, to generate pulse laser light. The pulse laser light may be generated according to a periodic turn-on/off operation of the modulator 76. For example, the pulse laser light may be generated when the modulator 76 is turned on, and the pulse laser light may not be generated when the modulator 76 is turned off.

The first mirror 62 may reflect about 100% laser light, and reflect about 5% to about 20% of laser light. The first mirror 62 may include a full mirror or FBG that totally reflects laser light. The second mirror 64 may include an FBG or output coupler that semi-transmits laser light. Laser light generated between the first and second mirrors 62 and 64 may be outputted to an end cap 68 or a collimator through a pigtail optical fiber 29 extended from the second mirror 64.

Referring to FIG. 8A, the active optical module 70 may have a forward pumping mode where an optical coupler is disposed in a direction from the first mirror 62 to the second mirror 64. The optical coupler 30 may be one of optical couplers 100 and 200, and may be disposed at a second optical fiber 20 adjacent to the first mirror 62. Herein, pulse laser light may be outputted from the second mirror 64 to the end cap 68 through a pigtail optical fiber 29. A hollow optical block 30 may be disposed in a direction from the first mirror 62 to the second mirror 64. Pump light may travel along the second optical fiber 20 extended from the first mirror 62 to the second mirror 64, and be sufficiently absorbed. In the forward pumping mode, accordingly, the travel direction of the pump light may be the same as the output direction of the pulse laser light, in the second optical fiber 20.

Referring to FIG. 8B, the active optical module 70 may have a backward pumping mode where the optical fiber coupler 30 is disposed in a direction from the second mirror 64 to the first mirror 62. The optical coupler 30 may be one of optical couplers 100 and 200, and may be disposed at a second optical fiber 20 adjacent to the first mirror 62. The hollow optical block 30 may be disposed in a direction from the second mirror 64 to the first mirror 62. Pump light may travel along the second optical fiber 20 extended from the second mirror 64 to the first mirror 62, and be sufficiently absorbed. In the backward pumping mode, accordingly, the travel direction of pump light may be opposite to the output direction of pulse laser light, in the second optical fiber 20.

Referring to FIG. 8C, the active optical module 70 may have a bidirectional pumping mode where a plurality of optical couplers are disposed to face each other at the second optical fiber 20 adjacent to the first and second mirrors 62 and 64. The plurality of optical couplers may be one of optical couplers 100 and 200. Each of the optical couplers may supply pump light in an opposite direction with each other to the second optical fiber 20 between the first and second mirrors 62 and 64. One of the optical couplers may be disposed in a forward direction at the second optical fiber 20 adjacent to the first mirror 62, and one of the optical couplers may be disposed in a backward direction at the second optical fiber 20 adjacent to the second mirror 64. Pump light may travel along the second optical fiber 20 between the first and second optical fibers 62 and 64, and be sufficiently absorbed into the core 21. In the bidirectional pumping mode, accordingly, laser light may be generated by pump light that is transferred in different opposite directions, in the second optical fiber 20 between the first and second mirrors 62 and 64.

Referring to FIG. 8D, the active optical module 70 may have a multiple forward pumping mode where a plurality of optical couplers are disposed in the same direction at the second optical fiber 20 between the first and second mirrors 62 and 64. The plurality of optical couplers may be one of optical couplers 100 and 200, and may transfer pump light having the same direction at the second optical fiber 20. Each of the optical couplers may be disposed in a forward direction between the first and second mirrors 62 and 64. When pump light supplied from the first optical coupler is depleted in the second optical fiber 20, pump light is resupplied from the second optical coupler, and thus, an output of laser light can sequentially increase. The intensity of the pump light supplied from the second optical coupler may be greater than that of the pump light supplied by the first optical coupler.

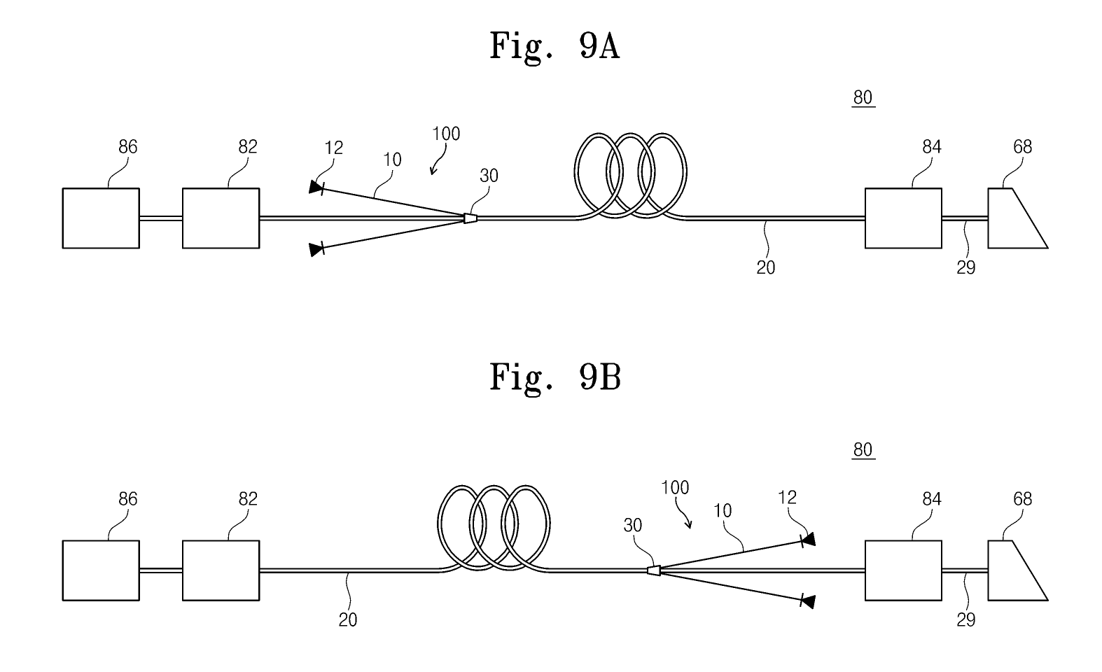

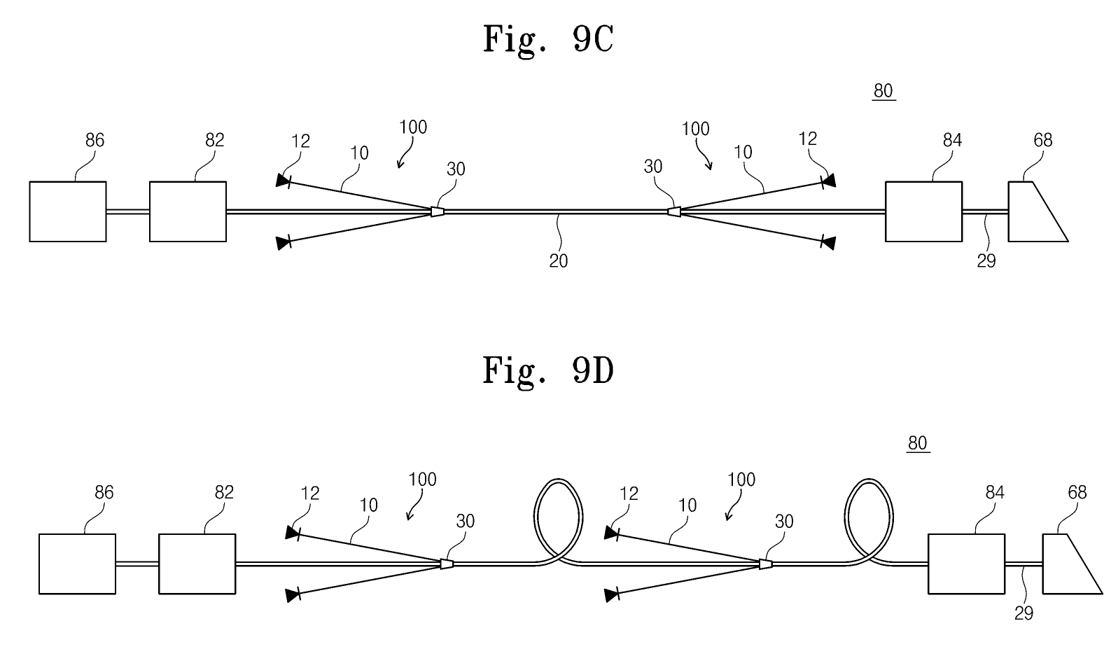

FIGS. 9A to 9D are views illustrating an active optical module 80 according to a third embodiment of the present inventive concept.

Referring to FIGS. 9A to 9D, the active optical module 80 may include a laser optical amplifier 80 where a signal source 86 and first isolator 82 are formed at one side of optical coupler, and a second isolator 84 is formed at the other side of optical coupler. The laser optical amplifier 80 may amplify laser light 86 with pump light which is transferred from the optical coupler 30. The signal source 86 may include a semiconductor light source, an output terminal of an optical amplifier, and an optical fiber laser. A pump light source 12 may supply pump light to a second optical fiber 20. In output laser light, a signal outputted from the signal source 86 may be amplified and outputted. Accordingly, the laser optical amplifier 80 may output laser light that is amplified from the signal of the signal source 86.

The first and second isolators 82 and 84 may transfer laser light to an end cap 68 along the second optical fiber 20. The first isolator 82 may pass the signal outputted from the signal source 86. On the other hand, the first isolator 82 may cut off laser light that returns to the signal source 86. The second isolator 82 may pass laser light that travels to the end cap 68 through a pigtail optical fiber 29. On the other hand, the second isolator 82 may cut off laser light that returns from the end cap 68 to the second optical fiber 20 through the pigtail optical fiber 29. The second isolator 82 may not be provided.

Referring to FIG. 9A, the active optical module 80 may have a forward pumping mode where an optical coupler is disposed in a direction from the first isolator 82 to the second isolator 84. The optical coupler 30 may be one of optical couplers 100 and 200, and may be disposed at a second optical fiber 20 adjacent to the first isolator 82. Herein, a hollow optical block 30 may be disposed in a direction from the first isolator 82 to the second isolator 84. Output laser light may be outputted from the second isolator 84 to the end cap 68 through a pigtail optical fiber 29. Pump light may travel along the second optical fiber 20 extended from the first isolator 82 to the second isolator 84, and be sufficiently absorbed. In the forward pumping mode, accordingly, the travel direction of the pump light may be the same as the output direction of the amplified output laser light, in the second optical fiber 20.

Referring to FIG. 9B, the active optical module 80 may have a backward pumping mode where the optical fiber coupler 30 is disposed in a direction from the second isolator 84 to the first isolator 82. The optical coupler 30 may be one of optical couplers 100 and 200, and may be disposed at the second optical fiber 20 adjacent to the second isolator 84. The hollow optical block 30 may be disposed in a direction from the second isolator 84 to the first isolator 82. Pump light may travel along the second optical fiber 20 extended from the second isolator 84 to the first isolator 82, and be sufficiently absorbed. In the backward pumping mode, accordingly, the travel direction of pump light may be opposite to the output direction of the amplified output laser light, in the second optical fiber 20.

Referring to FIG. 9C, the active optical module 80 may have a bidirectional pumping mode where a plurality of optical couplers are disposed to face each other at the second optical fiber 20 adjacent to the first and second isolators 82 and 84. The plurality of optical couplers may be one of optical couplers 100 and 200. One of the optical couplers may be disposed in a forward direction at the second optical fiber 20 adjacent to the first isolator 82, and one of the optical couplers may be disposed in a backward direction at the second optical fiber 20 adjacent to the second isolator 84. Pump light may travel along the second optical fiber 20 between the first and second isolators 82 and 84, and be absorbed. In the bidirectional pumping mode, accordingly, amplified laser light may be generated by pump light that is transferred in different opposite directions, in the second optical fiber 20 between the first and second isolators 82 and 84.

Referring to FIG. 9D, the active optical module 80 may have a multiple forward pumping mode where a plurality of optical couplers are disposed at the second optical fiber 20 between the first and second isolators 82 and 84. The plurality of optical couplers may be one of optical couplers 100 and 200, and may be disposed in the same direction from the first isolator 82 to the second isolator 84. Each of the optical couplers may transfer pump light to the second optical fiber 20, from the first isolator 82 to the second isolator 84. When pump light supplied from the first optical coupler is depleted in the second optical fiber 20, pump light is resupplied from the second optical coupler, and thus, the amplification of laser light can sequentially increase. The intensity of the pump light supplied from the second optical coupler may be greater than that of the pump light supplied by the first optical coupler.

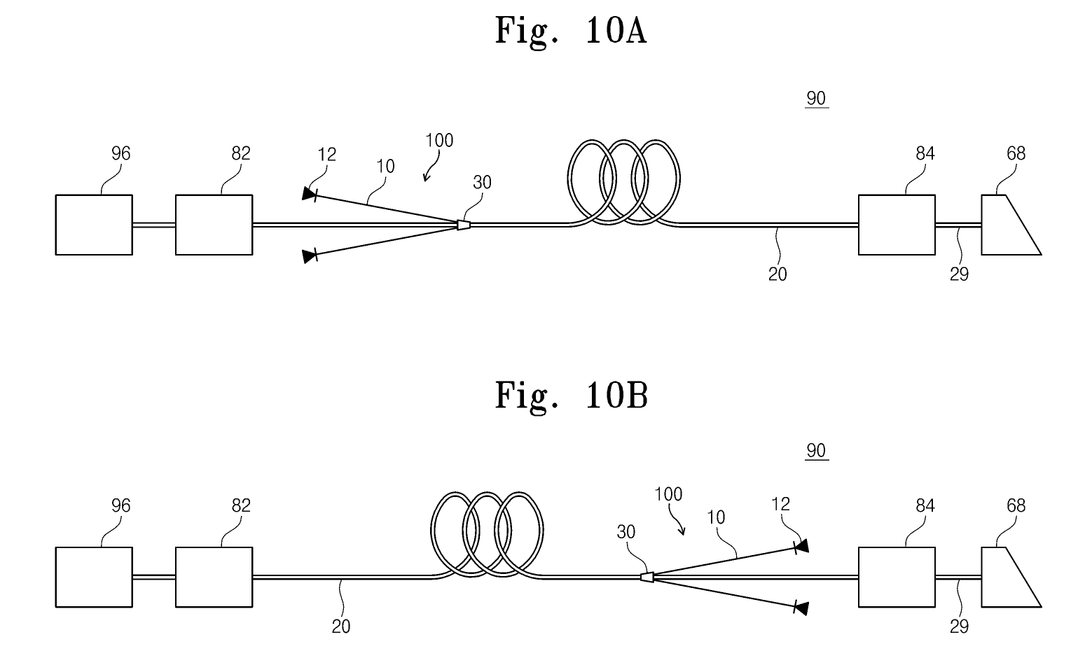

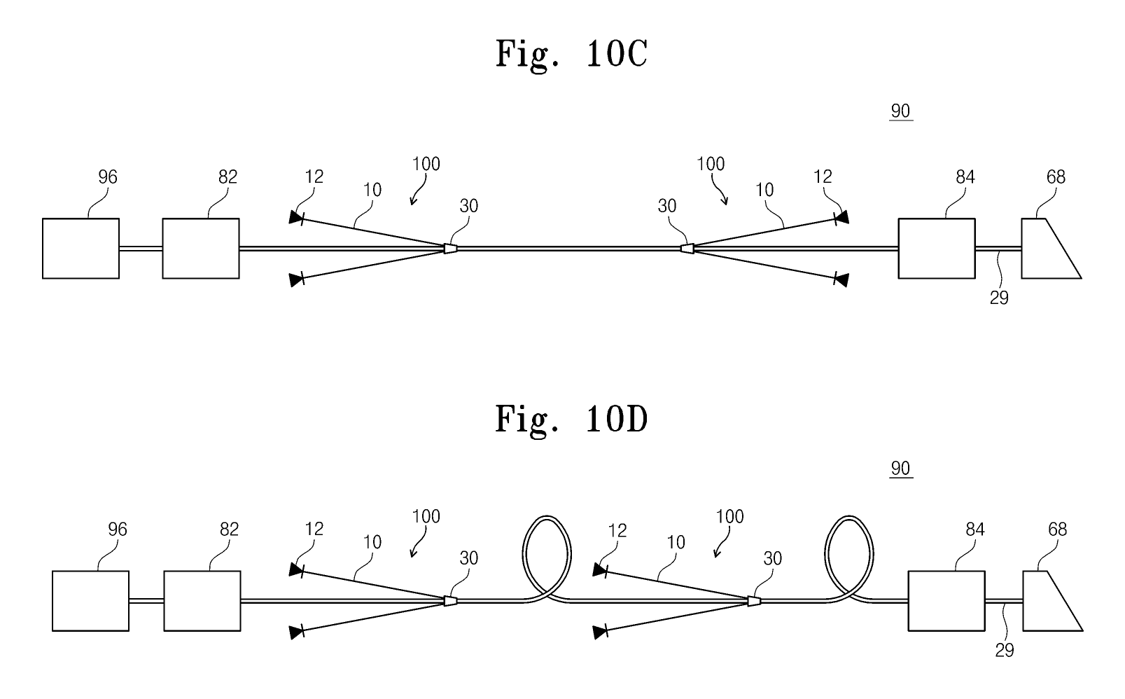

FIGS. 10A to 10D are views illustrating an active optical module 90 according to a fourth embodiment of the present inventive concept.

Referring to FIGS. 10A to 10D, the active optical module 90 may include a Master Oscillator-Power-Amplifier (MOPA) optical amplifier 90 where a master oscillator 96 and first isolator 82 are formed at one side of the optical coupler 30, and a second isolator 84 is formed at the other side of the optical coupler. The MOPA optical amplifier 90 may amplify laser light with pump light which is transferred from the optical coupler 30. A pump light source 12 may supply pump light to a second optical fiber 20 through the optical coupler. Laser light may be outputted as pulse laser light according to a pulse signal inputted from the master oscillator 96. The master oscillator 96 may include a frequency oscillator that generates a pulse signal.

The first and second isolators 82 and 84 may transfer laser light to an end cap 68 along a second optical fiber 20. The first isolator 82 may pass a signal outputted from a signal source 92. On the other hand, the first isolator 82 may cut off laser light that returns to the signal source 92. The second isolator 82 may pass laser light that travels to the end cap 68 through a pigtail optical fiber 29. On the other hand, the second isolator 82 may cut off laser light that returns from the end cap 68 to the second optical fiber 20 through the pigtail optical fiber 29. The second isolator 82 may not be provided.

Referring to FIG. 10A, the active optical module 90 may have a forward pumping mode where an optical coupler is disposed in a direction from the first isolator 82 to the second isolator 84. The optical coupler 30 may be one of optical couplers 100 and 200, and may be disposed at a second optical fiber 20 adjacent to the first isolator 82. Herein, a hollow optical block 30 may be disposed in a direction from the first isolator 82 to the second isolator 84. Pulse laser light may be outputted from the second isolator 84 to the end cap 68 through a pigtail optical fiber 29. Pump light may travel along the second optical fiber 20 extended from the first isolator 82 to the second isolator 84, and be sufficiently absorbed. In the forward pumping mode, accordingly, the travel direction of the pump light may be the same as the output direction of amplified pulse laser light, in the second optical fiber 20.

Referring to FIG. 10B, the active optical module 90 may have a backward pumping mode where the optical fiber coupler 30 is disposed in a direction from the second isolator 84 to the first isolator 82. The optical coupler 30 may be one of optical couplers 100 and 200, and may be disposed at the second optical fiber 20 adjacent to the second isolator 84. The hollow optical block 30 may be disposed in a direction from the second isolator 84 to the first isolator 82. Pump light may travel along the second optical fiber 20 extended from the second isolator 84 to the first isolator 82, and be sufficiently absorbed. In the backward pumping mode, accordingly, the travel direction of pump light may be opposite to the output direction of amplified pulse laser light, in the second optical fiber 20.

Referring to FIG. 10C, the active optical module 90 may have a bidirectional pumping mode where a plurality of optical couplers are disposed to face each other at the second optical fiber 20 adjacent to the first and second isolators 82 and 84. The plurality of optical couplers may be one of optical couplers 100 and 200. Each of the optical couplers may transfer pump light in different opposite directions, at the second optical fiber 20 between the first and second isolators 82 and 84. One of the optical couplers may be disposed in a forward direction at the second optical fiber 20 adjacent to the first isolator 82, and one of the optical couplers may be disposed in a backward direction at the second optical fiber 20 adjacent to the second isolator 84. In the bidirectional pumping mode, accordingly, pulse laser light may be amplified by pump light that is transferred in different opposite directions, in the second optical fiber 20 between the first and second isolators 82 and 84.

Referring to FIG. 10D, the active optical module 90 may have a multiple forward pumping mode where a plurality of optical couplers are disposed at the second optical fiber 20 between the first and second isolators 82 and 84. The plurality of optical couplers may be one of optical couplers 100 and 200. Each of the optical couplers may transfer pump light in a direction from the first isolator 82 to the second isolator 84. When pump light supplied from the first optical coupler is depleted in the second optical fiber 20, pump light is resupplied from the second optical coupler, and thus, the amplification of laser light can sequentially increase. The intensity of the pump light supplied from a second optical coupler may be greater than that of the pump light supplied by a first optical coupler.

According to the embodiments of the present inventive concept, the optical coupler may include the hollow optical block having the coupling surface that is joined to the facet of the optical fiber. The coupling surface may include the inner tapering region or side wall of the hollow optical block. Accordingly, the optical coupler can increase or maximize coupling efficiency. Also, the hollow optical block concentrates the pump light in the second optical fiber, and thus can efficiently supply the pump light to the core of the second optical fiber.

The above-disclosed subject matter is to be considered illustrative, and not restrictive, and the appended claims are intended to cover all such modifications, enhancements, and other embodiments, which fall within the true spirit and scope of the present inventive concept. Thus, to the maximum extent allowed by law, the scope of the present inventive concept is to be determined by the broadest permissible interpretation of the following claims and their equivalents, and shall not be restricted or limited by the foregoing detailed description.

What is claimed is:

1. An optical coupler comprising:
at least one first optical fiber transferring pump light;
a second optical fiber comprising a cladding with a facet enlarged from a first outer diameter to a second outer diameter, and transmitting the pump light which is transferred through the first optical fiber; and
a hollow optical block comprising a through hole passing the cladding with the first outer diameter, an incident surface connected to the first optical fiber at a side end of the through hole, and a coupling surface joined to the facet of the second optical fiber at the other side end of the through hole facing the incident surface.

2. The optical coupler of claim 1, wherein the coupling surface of the hollow optical block comprises an inner tapering region of which an inner diameter increases toward a side of the hollow optical block.

3. The optical coupler of claim 2, wherein the facet of the second optical fiber comprises an inclined facet joined to the inner tapering region of the hollow optical block.

4. The optical coupler of claim 3, wherein the hollow optical block has elasticity by which an inner diameter of the hollow optical block is increased and decreased in the inner tapering region.

5. The optical coupler of claim 3, wherein an outer diameter of the hollow optical block is the same as an outer diameter of a second portion of the second optical fiber, at the incident surface.

6. The optical coupler of claim 1, wherein the coupling surface comprises a side wall of the hollow optical block parallel to the incident surface.

7. The optical coupler of claim 6, wherein the facet of the second optical fiber comprises a vertical facet joined to the side wall of the hollow optical block.

8. The optical coupler of claim 7, wherein an outer diameter of hollow optical block at the incident surface is the same as an outer diameter at the side wall.

9. The optical coupler of claim 1, wherein the hollow optical block further comprises an external tapering region concentrating the pump light on the second optical fiber when an outer diameter thereof at the incident surface is greater than an outer diameter of a second portion of the cladding.

10. The optical coupler of claim 1, wherein the second optical fiber further comprises a core transmitting single-mode light or multi-mode light.

11. The optical coupler of claim 10, wherein the core comprises a rare-earth element.

12. An active optical module comprising:
a pump light source supplying pump light;
an optical coupler comprising: at least one first optical fiber transferring the pump light; a second optical fiber comprising a cladding with a facet enlarged from a first outer diameter to a second outer diameter, and transmitting the pump light which is transferred through the first optical fiber; and a hollow optical block comprising a through hole passing the cladding with the first outer diameter, an incident surface connected to the first optical fiber at a side end of the through hole, and a coupling surface joined to the facet of the second optical fiber at the other side end of the through hole facing the incident surface;
a first optical element formed at an end of the second optical fiber which passes through the optical coupler; and
a second optical element formed at the other end of the second optical fiber facing the first optical element, the second optical element emits the laser light which is generated by the second optical fiber.

13. The active optical module of claim 12, wherein the active optical module has a forward pumping mode where the hollow optical block of the optical coupler is disposed in a direction from the first optical element to the second optical element.

14. The active optical module of claim 12, wherein the active optical module has a backward pumping mode where the hollow optical block of the optical coupler is disposed in a direction from the second optical element to the first optical element.

15. The active optical module of claim 12, wherein,
the optical coupler is provided in plurality, and
the active optical module has a bidirectional pumping mode where hollow optical blocks of the optical couplers are disposed in a direction facing each other.

16. The active optical module of claim 12, wherein,
the optical coupler is provided in plurality, and
the active optical module has a multiple forward pumping mode where hollow optical blocks of the optical couplers are disposed toward second optical elements.

17. The active optical module of claim 12, wherein each of the first and second optical elements comprises first and second mirrors.

18. The active optical module of claim 17, further comprising a modulator formed at the optical fiber between the first and second mirrors.

19. The active optical module of claim 12, wherein each of the first and second optical elements comprises first and second isolators.

20. The active optical module of claim 19, further comprising a signal source or master oscillator formed at the second optical fiber outside the first isolator facing the second optical element.
